(19) United States
(12) Patent Application Publication
(10) Pub. No.: US 2025/0389583 A1
(43) Pub. Date: Dec. 25, 2025

(54) DEVICES, SYSTEMS, AND METHODS FOR MULTI-WAVELENGTH IMAGING

(71) Applicant: OnLume Inc., Madison, WI (US)

(72) Inventors: Adam Uselmann, Madison, WI (US); Christie Lin, Madison, WI (US); Daniel P. Seemuth, Madison, WI (US); Emmanuel Mannoh, Madison, WI (US); Jacob Tatro, Madison, WI (US)

(21) Appl. No.: 19/032,761

(22) Filed: Jan. 21, 2025

Related U.S. Application Data
(60) Provisional application No. 63/622,389, filed on Jan. 18, 2024.

(51) Int. Cl. G01J 3/28; G01J 3/02; G01J 3/44

(52) U.S. Cl. CPC G01J 3/2823; G01J 3/0208; G01J 3/0237; G01J 3/0256; G01J 3/0272; G01J 3/2803; G01J 3/4406; G01J 2003/2826

(57) ABSTRACT

Provided herein are devices, systems, and methods for medical imaging. In particular, provided herein are devices, systems, and methods for real-time simultaneous multi-wavelength fluorescence and color imaging, e.g., configured for use during fluorescence guided diagnostic and surgery (FGS) applications.

### FIELD

The present disclosure relates to devices, systems, and methods for medical imaging. Particularly, provided herein are devices, systems and methods for real-time simultaneous multi-wavelength fluorescence and color imaging, e.g., configured for use during fluorescence guided diagnostic and surgery (FGS) applications.

### BACKGROUND

Medical imaging advances have led to improvements in diagnostic accuracy, patient selection, and surgical planning. Fluorescent agents and fluorescence-guided surgery have proven to be an advanced and clinically useful technique applicable in many fields of surgery. Ideally, the surgeon utilizes fluorescent images superimposed with images of tissue morphology. However, a lack of systems and devices that can provide ease of use alongside high-sensitivity multi-wavelength imaging hamper expansion of fluorescence-guided application.

### SUMMARY

Provided herein are devices, systems, and methods for multi-wavelength fluorescence and color imaging.

In some embodiments, the optical system comprises a handheld optical device. In some embodiments, the handheld optical device comprises a light collection unit that collects light from a desired target area; an electronic tunable lens configured to receive output from the lens assembly; and one or more detection assemblies configured to receive and detect one or more desired wavelength ranges of light from output of the tunable lens.

In some embodiments, the handheld optical device comprises mounting hardware. In some embodiments, the handheld optical device is attached to an articulated arm and/or surgical robot.

In some embodiments, the one or more detection assemblies comprise: one or more of: lenses, collimators, and filters; and a detector. In some embodiments, the handheld optical device comprises two detection assemblies. In some embodiments, the one or more detection assemblies comprise a fluorescent light detection assembly. In some embodiments, the fluorescent light detection assembly comprises a multi-band filter. In some embodiments, the one or more detection assemblies comprise a white light detection assembly.

In some embodiments, the handheld optical device further comprises a beam divider to split light output of the tunable lens to the one or more detection assemblies.

In some embodiments, the handheld optical device further comprises one or more mirrors to direct light path to the one or more detection assemblies.

In some embodiments, the light collection unit is a lens assembly. In some embodiments, the light collection unit is an endoscope or colposcope attachment.

In some embodiments, the handheld optical device further comprises a distance sensor in communication with the electronic tunable lens. In some embodiments, the distance sensor is at or near the distal end of the light collection unit. In some embodiments, the device or system comprises a focusing controller.

In some embodiments, the system comprises a light source assembly for providing one or more transient and temporally separate illumination and/or excitation lights to a target. In some embodiments, the illumination and/or excitation lights are switched at a rate of at least 100 Hz. In some embodiments, the light source assembly comprises a fluorescence excitation light source. In some embodiments, the light source assembly comprises a white light source.

In some embodiments, the light source assembly is integral to the handheld optical device. In some embodiments, the light source assembly is separate from the handheld optical device.

In some embodiments, the system further comprises an image display. In some embodiments, the image display is integral to the handheld optical device. In some embodiments, the image display is separate from the handheld optical device.

In some embodiments, the system further comprises an image processing component. In some embodiments, the image processing component superimposes images acquired from at least two or each of the one or more detection assemblies.

In some embodiments, the system further comprises a communication component. In some embodiments, the communication component is embedded in the device. In some embodiments, the communication component sends images from the device to the image display and/or the image processing component.

In some embodiments, the system further comprises an information processing component. In some embodiments, the information processing component is in electronic communication with one or more or all of: the device, the image display, and the image processing component. In some embodiments, the information processing component and/or the image processing component comprises an artificial analysis component.

Also provided herein are methods for multi-wavelength fluorescence imaging of a target tissue. In some embodiments, the methods comprise acquiring one or more fluorescence images of at least one fluorophore or fluorescent probe in the target tissue with a system as described herein. In some embodiments, the methods further comprise providing at least one fluorophore or fluorescent probe to the target tissue and/or administering the at least one fluorophore or fluorescent probe to a subject. In some embodiments, the methods further comprise acquiring one or more white light images of the target tissue.

In some embodiments, the target tissue is a diseased tissue. In some embodiments, the target tissue comprises cancerous tissue. In some embodiments, the target tissue comprises normal tissue structures.

Other aspects and embodiments of the disclosure will be apparent in light of the following detailed description.

### BRIEF DESCRIPTION OF THE DRAWINGS

FIG. 1A is a schematic illustration of the optical light path of one embodiment of the optical device 100. FIG. 1B shows the optical light path embodiment of FIG. 1A exemplified in a handheld optical device 100 with an integrated display screen 500 and handle 510.

FIG. 2 are a series of illustrations showing an exemplary handheld optical device 100.

FIG. 3 is a chart showing an exemplary transient multi-wavelength illumination protocol.

FIGS. 4A and 4B are schematic illustrations of two exemplary optical devices 100 having two detections assemblies 400 folded in a parallel design (FIG. 4A) or a single detection assembly 400 (FIG. 4B), shown here as an exemplary fluorescent detection assembly.

FIG. 5 is a flow chart of image analysis, patient data, and integration into workflows for using the device, particularly for fluorescence-guided surgeries.

### DETAILED DESCRIPTION

The present disclosure provides technology related to devices, systems, and methods for medical imaging, specifically devices, systems, and methods useful with fluorescence-guided surgery. The devices and systems provide simultaneous multi-wavelength wide-field imaging (e.g., simultaneous and/or overlapping viewing of white light and fluorescent images) at high sensitivity in a convenient handheld design which adjusts focus based on distance from target without manual adjustment. As described in detail below, the devices contain a lens assembly that collects light from the desired target or target plane, collimates and outputs it into an electronic tunable lens which facilitates focus adjustments in less time than mechanical means thereby giving the device the capability of operating over broad and variable working distances, expected for handheld devices. The light then passes to one or more channels for detection. The device may include a beamsplitter or other optical element to separate the collected light for color and fluorescence imaging and/or a multi-band filter for simultaneous multi-wavelength fluorescence imaging.

Section headings as used in this section and the entire disclosure herein are merely for organizational purposes and are not intended to be limiting.

### Definitions

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, the term “in electronic communication” refers to devices or modules (e.g., computers, processors, etc.) that are configured to communicate with one another through direct or indirect signaling.

As used herein, the terms “processor” and “central processing unit” or “CPU” are used interchangeably and refer to a device that is able to read a program from a computer memory and perform a set of steps according to the program. As used herein, the terms “computer memory” and “computer memory device” refer to any storage media readable by a computer processor. Examples of computer memory include, but are not limited to, RAM, ROM, computer chips, digital video discs (DVD), compact discs (CDs), hard disk drives (HDD), and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks. The computer readable medium may be non-transitory or include a device of system that is not a transitory signal.

A “fluorophore” or “fluorescent probe” generally refers to any object or molecule that produces fluorescent light. The fluorophore or fluorescent probe absorbs incident energy of a certain wavelength or wavelength range and, in response, emits light energy at a different wavelength or wavelength range. The absorption of light is often referred to as the excitation, while the emission of longer wave lights as the emission. A fluorophore refers to a molecule or a functional group in a molecule that absorbs energy of a specific wavelength and re-emits energy at a different wavelength. Many commercially available fluorophores are suitable for use with a subject. Suitable fluorophores include indocyanine green (ICG), Qdot® 605, Qdot® 800, AlexaFluor® 680 and AlexaFluor® 750 as provided by Invitrogen of San Diego, Calif. Both organic and inorganic substances can exhibit fluorescent properties, and are suitable for use. A fluorescent probe comprises a fluorophore attached to another molecule, such as a biomolecule, for example, a protein (e.g., an antibody) or a small molecule. The biomolecule or small molecule may be used as a targeting agent for a particular tissue, structure, marker, or disease state.

A “subject” or “patient” may be human or non-human and may include, for example, animal strains or species used as “model systems” for research purposes, such a mouse model as described herein. Likewise, patient may include either adults or juveniles (e.g., children). Moreover, patient may mean any living organism, preferably a mammal (e.g., human or non-human). In one embodiment of the methods and systems provided herein, the mammal is a human.

As used herein, an element of the present technology is “integral” to another element of the present technology when the two elements are manufactured, assembled, or provided as a single piece or device.

As used herein, an element of the present technology is “separate” from another element of the present technology when the two elements are manufactured or provided as separate pieces or devices.

Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting. Illustrative embodiments of the invention are shown in the figures. It should be understood that the invention is not limited to these particular examples.

### Devices and Systems

The technology relates to optical devices and systems for medical imaging, e.g., medical imaging diagnostics and image-guided surgeries. The disclosed devices and system facilitate rapid focus adjustments in real-time without manual adjustments or movement of any physical mechanisms. Sensors and detectors in the devices and systems generate a map or image of fluorescence, other tissue optical properties including autofluorescence, polarization, or multispectral information, and/or white light using brightness adjustments to account for variations in the working distance.

In some embodiments, the systems comprise an optical device 100. The optical device comprises: a light collection unit that collects light from a desired target area; an electronic tunable lens configured to receive output from the lens assembly; and one or more detection assemblies configured to receive and detect one or more desired wavelength ranges of light from output of the tunable lens.

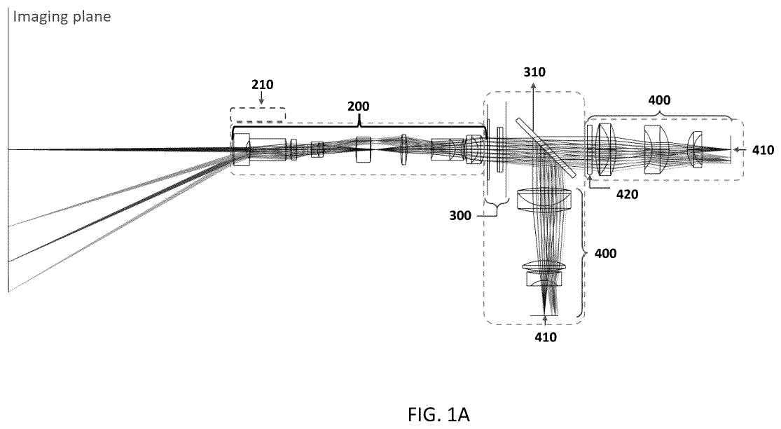

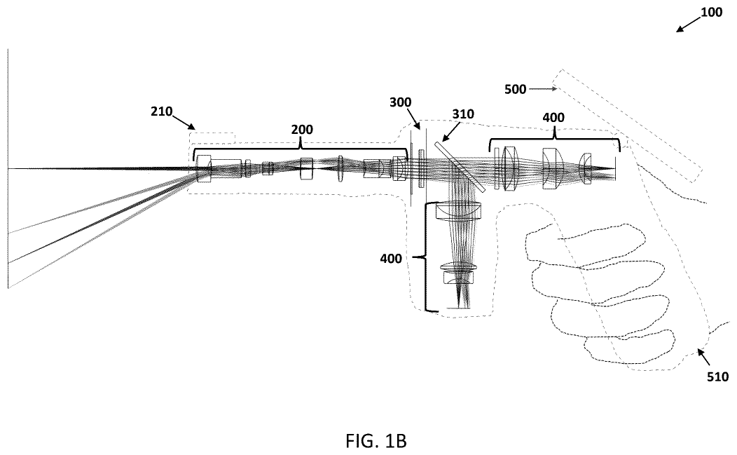

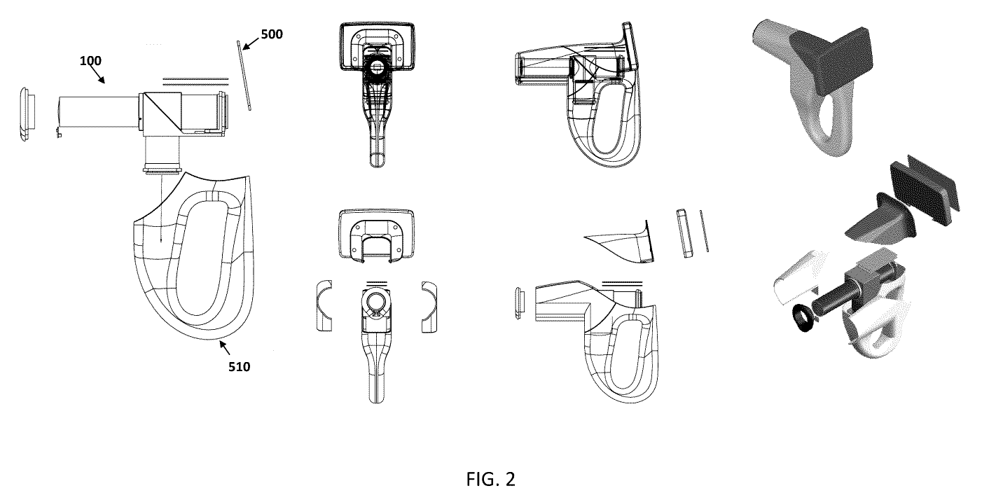

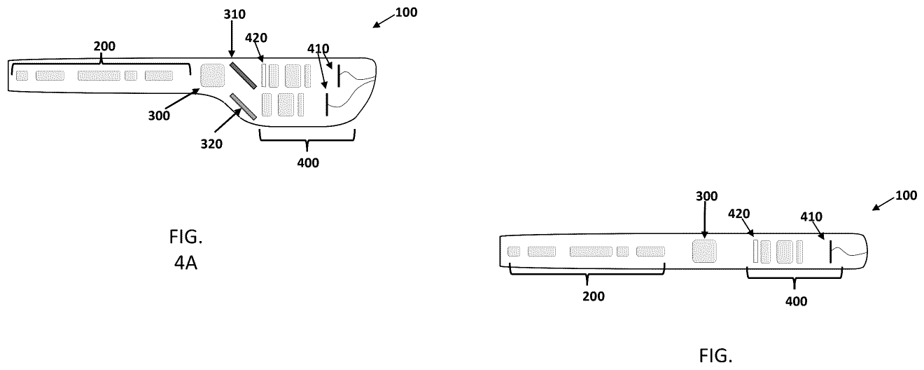

As shown FIGS. 1 and 4, optical device 100 may be used by the surgeon or other clinical staff in a handheld configuration. Accordingly, in some embodiments, the optical device is a handheld optical device. The optical device may be installed in any framework or chassis that provide ease of handling by a single individual, as shown in FIGS. 2 and 4. In some embodiments, the optical device has a handle 510 (FIGS. 1B and 2). In some embodiments, the optical device is provided as a pen-shaped device designed to be cradled between a thumb and fingers, FIG. 4.

Alternatively or in addition, the optical device can be mounted or attached (e.g., through mounting hardware or a holster) to an articulated arm or surgical robot. In some embodiments, the system or device may be mounted to the arm of a minimally invasive surgical robot such that a portion of the device extends the length of the arm and other portions of the device are located at or near the articulation point of the arm, e.g., similar to the surgical Da Vinci robot. In some embodiments, the device or system is used with an open-field surgical robot for positioning over a subject.

As such, the optical device has characteristics making it feasible to be operated by a single individual by holding in a single hand. Generally, this would include an optical device that is less than about 5 pounds or 2 kg. In some embodiments, the optical device weighs approximately 500 g to 1000 g or 1 to 2 lbs. In some embodiments, the optical device weights less than approximately 500 g or 1 lb.

In some embodiments, the optical device is less than about nine inches long. In some embodiments, the optical device is up to about six inches in height. In some embodiments, the optical device is between about four and about nine inches long. In some embodiments, the optical device is about three to about six inches in height. In some embodiments, the optical device is less than three inches in height. In some embodiments the diameter of the device or the handle of the device is less than about three inches.

The light collection unit 200 of the optical device includes any of a series of lenses, filters, optical fibers which direct the light from target area to the other components of the device. An aperture or other opening may be used to control the light entering the light collection unit.

In some embodiments, the light collection unit is a lens assembly 200. A lens

assembly focuses the light from the target through a series of lenses aligned with respect to each other on the light path. The lenses can be fixed in a desired alignment position with respect to the other lenses in the assembly, can be configured to have at least one degree of freedom of movement with respect to the other lenses in the assembly or with respect to the optical path, or a combination of fixed and moveable lenses can be used in the lens assembly. The lens assembly may be configured within a lens barrel.

In some embodiments, the light collection unit is an endoscope, laparoscope, or colposcope attachment. As such, the optical device can include endoscope components, such as an endoscope image capturing optical assembly in which the remaining portion of the device is attached to the external or proximal portion of the endoscope image capturing optical assembly. Alternatively, the light collection unit can include the imaging optical system of a long working distance microscope, such as a colposcope.

The optical device includes an electronic tunable lens 300. An electronic tunable lens facilitates quick focus adjustments as compared to any mechanical focus adjustments. An electronic tunable lens is commonly adjusted by applying a current to the lens or a voice coil or bobbin around the periphery of the lens, thereby changing the focal length of the lens very rapidly (within a few milliseconds) by means of a complementary controller, and adjusting the lens to the desired focal length within a few milliseconds. Electronic tunable lenses produce the same optical effects as moving an entire lens centimeters with only a few microns of radius change. The electronic tunable lens can be a fast electrically tunable lens model number EL-12-30-TC or EL-3-10 made by Optotune AG of Dietikon, Switzerland, depending on the desired diameter and configuration of the device.

In some embodiments, the electronic tunable lens is in communication with a distance sensor 210. Thus, in some embodiments, the optical device or system comprises a distance sensor, as shown in FIG. 1. The distance sensor may be at or near the distal end of the light collection unit (e.g., lens assembly 200). In addition to providing feedback regarding the working distance of the optical device for use in adjusting the focus, the distance sensor also enables brightness adjustments based on differences in working distance. The electronic tunable lens may be in communication with the distance sensor by means of a focusing controller. The distance sensor and focusing controller, individually or together, rapidly and seamlessly translate distance sensor measurements to the tunable lens to keep images in focus as working distance changes, e.g., due to hand motion.

The optical device includes one or more detection assemblies 400. Detection assemblies may also be referred to herein as detection channels or a particular type of light (e.g., color, white, fluorescent) channel (e.g., white light channel) and encompass an arrangement of lenses, collimators, and/or filters in the light path which focus and directs the light onto the sensor or detector 410 where the sensor or detector detects the light. In some embodiments, the optical device comprises a single detection assembly. FIG. 4B shows an exemplary device with only a single detection assembly. In some embodiments, the optical device comprises two detection assemblies. FIGS. 1 and 4A show an exemplary device with only a single detection assembly.

The one or more detection assemblies may direct the same type of light or different types of light. For example, the one or more detection assemblies may comprise at least one detection assembly to detect white light and at least one detection assembly to detect fluorescent light. Alternatively, the one or more detection assemblies may detect the same type of light but in a different manner, e.g., different wavelengths or polarizations. In some embodiments, the one or more detection assemblies include a fluorescent detection assembly. In some embodiments, the one or more detection assemblies include a white light detection assembly. In some embodiments, the one or more detection assemblies include a fluorescent detection assembly and a white light detection assembly.

In some embodiments, the fluorescent detection assembly is configured to allow detection of one or more fluorophores that are spectrally distinct. Spectrally distinct fluorophores are characterized by substantially non-overlapping emission signals, e.g., emission signals include substantially different wavelength ranges. In some embodiments, the fluorescent light detection assembly comprises a multi-band filter. For example, a Cy2 fluorophore emits a signal at a wavelength of light of about 510 nm and is spectrally distinct from a Cy5 fluorophore emitting a signal at a wavelength of light of about 670 nm. Accordingly, the optical device may be configured for a variety of different types and numbers of fluorophores, further increasing the specificity and capabilities for the optical device and systems thereof.

In some embodiments, one fluorophore can be detected. In some embodiments, 2, 3, or 4, or more fluorophores can be detected simultaneously. In some embodiments, 2 fluorophores can be detected simultaneously. In some embodiments, 3 fluorophores can be detected simultaneously. In some embodiments, 4 fluorophores can be detected simultaneously.

In some embodiments, the optical device may further comprise a beam divider 310 (e.g., a beamsplitter or similar device) to split light output of the tunable lens 300 to the one or more detection assemblies 400 such that both receive light at substantially the same time. Accordingly, when the optical device comprises at least two detection assemblies, a beam divider may direct a portion of the light to each of the two or more detection assemblies. The beam divider may be configured to split the light at a designated ratio based on the number of detection assemblies and the type of light being detected. The beam divider may be configured to split the light as a function of the wavelength of the incident light, such as in polychroic beamsplitters.

In some embodiments, the optical device may further a mirror 320 or similar device to direct the light path to at least one of the one or more detection assemblies. By using a mirror or series of mirrors, the light paths of two more detection assemblies can be altered from a largely perpendicular direction, as in FIG. 1, to a more parallel direction, as in FIG. 4A, allowing greater flexibility in the orientation and design of the optical device.

Each of the one or more detection assemblies comprise a sensor or detector 410. Any individual detection assembly may comprise two or more individual detectors or sensors. In some embodiments, the sensor or detector can comprise any set of detection optical devices arranged to collect and record images from the target area. The detector may be a vidicon tube, charge-coupled device (CCD), silicon photoavalanche diode (SPAD), avalanche photodiode (APD) array (also considered herein an image intensifier), a CMOS detector, or the like.

In some embodiments, the sensor or detector includes a camera. The camera may be a color camera which captures a full color image of the target area, or a monochrome camera which captures one or more fluorescent emissions of the target area. For example, the camera may include a charge injection device (CID), charge modulation device (CMD), complementary metal oxide semiconductor image sensor (CMOS), silicon photoavalanche diode (SPAD), or charge coupled device (CCD) type sensor. The CMOS or CCD type sensor cameras can have a high frame rate or be configured to use every some may frames based on the transient light source configuration, as described below. The SPAD type sensor camaras have high temporal resolution suitable for measuring time-of-flight of excitation source light, fluorescence lifetimes, and surface mapping.

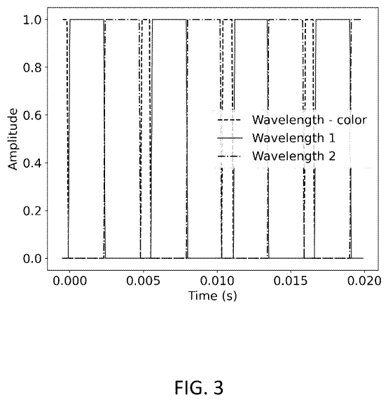

The system further comprises a light source assembly for providing illumination or excitations lights to a target area. In some embodiments, the light source assembly comprises a fluorescence excitation light source. In some embodiments, the light source assembly comprises a white light source. The light source assembly is configured to provide one or more transient and temporally separate illumination and/or excitation. This transient lighting technique allows multi-wavelength illumination and/or excitation on millisecond time scales (FIG. 3).

In some embodiments, the illumination and/or excitation lights are switched at a rate of greater than 50 Hz (e.g., greater than 60 Hz, greater than 70 Hz, greater than 80 Hz, greater than 90 Hz, greater than 100 Hz, greater than 120 Hz, greater than 130 Hz, greater than 140 Hz, greater than 150 Hz, greater than 160 Hz, greater than 170 Hz, greater than 180 Hz, greater than 190 Hz, greater than 200 Hz, or more). In some embodiments, the illumination and/or excitation lights are switched to result in pulse durations of less than 20 milliseconds (e.g., about 20 ms, about 19 ms, about 18 ms, about 17 ms, about 16 ms, about 15 ms, about 14 ms, about 13 ms, about 12 ms, about 11 ms, about 10 ms, about 9 ms, about 8 ms, about 7 ms, about 6 ms, about 5 ms, about 4 ms, about 3 ms, about 2 ms, about 1 ms, or less). Generally, the rate and duration of switching the illumination and/or excitation lights facilitate nearly simultaneous or simultaneous imaging of the multiple light outputs from the target area.

The light source assembly may target multiple wavelengths by exciting spectrally distinct (e.g., minimal emission overlap) fluorophores by cycling between multiple (e.g., two or more) excitation wavelength and leaving a small amount of at the end of the illumination cycle for white light illumination in order to also provide color images. The illumination duration for each wavelength can be extended or shortened based on the brightness of the fluorophores to be imaged. Brightness is dependent on the efficiency of the fluorophore, depth of the fluorophore, concentration of the fluorophore, and excitation illumination power, geometry, and wavelength. The duration of the illumination cycling can be performed statically (fixed in an implementation) or dynamically (changing based on image data collected).

The light source assembly may use any stable, high-speed light source for illumination of the target, including but not limited to LEDs (light emitting diodes), lasers, and xenon flash lamps, or any combinations thereof. Overall, using any light source or combinations of the light sources for illumination or excitation, the light source assembly provides any necessary light source for the desired type of light being detected/imaged, e.g., white light or fluorescence excitation light.

In some embodiments, the light source assembly comprises a series of LEDs. LEDs provide fast on and off times, well defined emission spectra and exceptional short and long-term stability. In some embodiments, the light source assembly comprises arrays of LED chips configured to emit light in a variety of wavelengths or colors, as well as white light. In some embodiments, the output of the light engine used for fluorescence excitation is collimated and/or filtered (e.g., with a narrow-band interference filter, or with a band-pass or short-pass spectral filter).

In some embodiments, the light source assembly comprises a unit for homogenizing different types of light sources (e.g., white light and fluorescence excitation light) at the target. The “homogenizing unit” may improve the uniformity of illumination of the different types of light sources at the target.

The light source assembly may be provided to the system in any way in which the target area is sufficiently illuminated. In some embodiments, the light source assembly is integral to the optical device. In some embodiments, the light source assembly is separate from the optical device.

In some embodiments, the system further comprises an image display 500. In some embodiments, the image display is integral to the handheld optical device, as shown in FIG. 1B. Thus, the surgeon or clinician is able to directly visualize the image in real-time on the device itself using a display monitor or something similar. In some embodiments, the image display is separate from the handheld optical device. In these instances, the images generated by the system and/or device are provided to a display external to the optical device (e.g., an external display monitor (e.g., a computer monitor), a wearable device (e.g., Augmented reality (AR) and Virtual Reality (VR) goggles), a robotic surgery device display). In some embodiments, the images are displayed or overlaid on the target area of interest itself. The image display may further display textual and/or graphical information (e.g., information for the type of image being shown). The image display may be adapted to systems for binocular vision.

In some embodiments, the system comprises an image processing component. The image processing component evaluates the image obtained by the system or device. All or a portion of the image processing component may be in the device itself. Alternatively, as described below, the device may be in communication with the image processing component, or portion thereof, external or separate to the device.

The image processing component may include the ability to transform the images creating enhanced images which may include highlighting, coloring, emphasis or de-emphasis of detail, digital filtering, among many other potential transformations, prior to, after or simultaneously with displaying the images on the display. The image processing component may transform the image to align and superimpose images acquired from at least two or each of the one or more detection assemblies or for multiple images acquired over time for brightness/contrast, ratio of brightness/contrast between detected lights, size, and orientation (e.g., pan, tilt and rotation). The image processing component may include frame operations including, but not limited to, frame summing or averaging, frame subtraction, ratiometric operations between images, operations defined by a machine learning algorithms, transparency, and image overlays.

For example, the brightness of a collected signal varies as you change a variety of collection parameters, including working distance, focus, and optical zoom. By calibrating the optical device across these parameters, the displayed brightness of the signal may be a calibrated brightness, avoiding false positives and false negatives (e.g., false positive or negative interpretations of well perfused tissue appearing dim and at risk of necrosis due to a larger working distance or higher optical zoom). The brightness adjustment may occur by the image processing component referencing the distance value reported by the distance sensor. For imaging fields with complex surfaces, a 2D distance sensor could provide brightness adjustment to subregions of the field, such that areas of the target area that are further from the camera are brightened to a greater degree than regions that are closer to the camera.

In some embodiments, the image processing component may analyze a baseline image with regard to illumination/excitation quality, brightness, quantitation, and focus. In some embodiments, the image processing component may analyze the signals of the target tissue as relative to a reference image (e.g., normal tissue). For example, comparing healthy tissue perfusion to perfusion of tissue at risk for impaired blood flow or comparing background signal from non-diseased tissue to a larger field of view and indicating areas above a certain relative signal level indicative of cancer targeted dye uptake in cancerous tissue.

In some embodiments, the image processing component may analyze the signals of the target tissue as relative to a reference light signal (e.g., a different dye or same dye with different spectral characteristics). The image processing component may compute ratiometric measures from two different detected light emissions (e.g., from a detectable dye). For example, comparing signals from two different dyes or fluorophores. This processing may reduce the impact of non-specific uptake and retention of a dye in background tissues. For example, a non-specific dye may be used as a reference for quantifying a targeted dye. Alternatively, fluorophore probes may emit one wavelength when bound to an intended target or in a target subcellular location versus unbound or non-specifically localized.

The image processing component may create time-course measurements of one or more detected light emissions (e.g., from a detectable dye). This may assess dynamic tissue functions such as ingress and egress timelines of indocyanine green (ICG) bound to plasma proteins as a surrogate measure of blood flow. The image process component may allow quantification of the light emissions (e.g., to inform future surgical annotation approaches and/or improve diagnostic accuracy of other dye-based imaging).

The image processing component, alone or in conjunction with the information processing component described below, may be used to increase diagnostic or surgical accuracy through methods which use a plurality subject data gathered during imaging procedures. The increased diagnostic or surgical accuracy may improve tissue margins during fluorescence-guided surgical resections, improve guidance for photodynamic therapies, improve detection of deep tissue signals, improve detection of non-effected tissues or structures within the target area.

The image processing component may incorporate data from other analyses of the target area gathered before or during the imaging procedure or surgery using the disclosed system, e.g., histopathology results. The image processing component may also generate results and/or reports based on the analysis of the image. For example, the image processing component may generate results and report which include the parameters in which the image was generated, e.g., illumination/excitation settings, detection settings, depth/working distance measurements, and the like.

The image processing component could be custom designed, licensed from third parties, or include commercially available image analysis software.

In some embodiments, the system comprises an information processing component. The information processing component can provide a variety of functions, including but not limited to: receiving and processing images generated from the device; receiving and storing details of the images, subject, imaging settings, or imaging purpose (e.g., tissue, type of surgery, etc.). In some embodiments, the information processing component is in electronic communication with one or more or all of: the device, the image display, and the image processing component.

In some embodiments, the information processing component comprises one or more of a computer processor, computer readable medium, and software. Any of a variety of computing devices may be utilized individually as the information processing component, including but not limited to, a desktop computer, a mainframe computer, a laptop computer, a personal digital assistant (PDA), a portable computer (e.g., mobile devices such as telephones), and a tablet computer (e.g., standard tablets, slates, mini tablets, phablets, customer handheld devices).

In some embodiments, the information processing component comprises a database containing subject data, historical data, or other desired information. The subject data, historic data, or other desired information may be provided by computer processor, computer readable medium, software, or be available through a web-based platform via a web browser across the Internet. Data storage by the information processing component includes data storage and management for individual subjects. In some embodiments, data storage also includes storage and management for multiple subjects, including, but not limited to, medical imaging results and details (e.g., images, device configuration, illumination/excitation configuration, dye or fluorophores utilized, and the like), relevant health history factors, additional relevant diagnostic results (e.g., histopathology, biomarker results and/or genotype), pre-procedure subject data (e.g., survival, recurrences, quality of life indicators, damage from prior therapies) and other relevant factors (e.g., body habits, socio-demographic factors) that impact diagnosis and treatment.

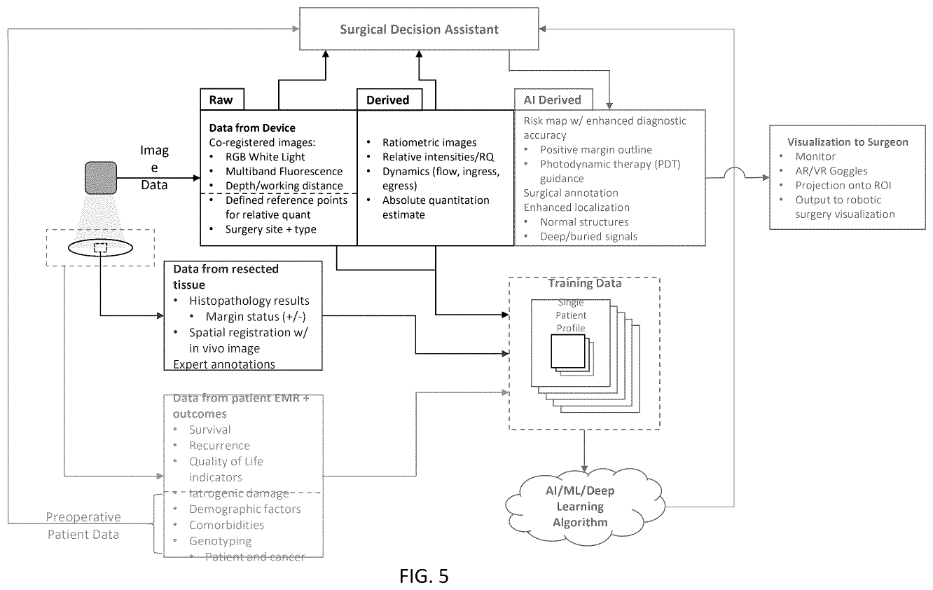

These data may be used to make comparative analysis and/or improve artificial intelligence capabilities of the system, which can then, in turn, be used to optimize use of the system, image analysis (e.g., via the image processing components), and diagnostic and surgical procedures. This application of machine learning to optimize the management of future patients may be either supervised or unsupervised. Accordingly, in some embodiments, the information processing component, or a device in electronic communication with the information processing component, comprises an artificial intelligence component (e.g., embodied in software running on a processor). In some embodiments, images generated by the device are transferred to the artificial intelligence component for analysis outside of or alongside of the image processing component. See FIG. 5 for a workflow of integration of image processing components and information processing components for use within the disclosed system.

In some embodiments, the information processing component, or a device in electronic communication with the information processing component, comprises a networking component. The networking component may receive and/or transmit information to and from the information processing component. For example, the networking component may be in communication with an electronic health record (EHR) system, which provides data and other medical information to the information processing component or artificial intelligence component.

In some embodiments, the system comprises a communication component. The communication component facilitates information flow from any of the components of the system and devices thereof. In some embodiments, the communication component communicates information from the optical device to the image display, the image processing component, or the information processing component, described below. In some embodiments, the communication component communicates information to any other component of the system, or between a component outside of the system (e.g., electronic medical records system).

In some embodiments, a portion or all of the communication component is wired. For example, in some embodiments, the communication component comprises wires or cables connecting the imaging device directly or indirectly to an information processing component. In some embodiments, a portion of or the entire communication component is wireless. Any desired wireless communication technology may be employed, including but not limited to, electromagnetic wireless telecommunications (e.g., wireless networking, cellular, satellite), and electromagnetic induction (such as light, magnetic, or electric fields or the use of sound). Where wireless networks are employed, any desired protocol can be used (e.g., ZigBee, EnOcean, Personal area networks, Bluetooth, TransferJet, ultra-wideband).

### Methods

The disclosure provides devices or systems for use with fluorescence-guided diagnostic and surgery applications for a target tissue. In some embodiments, the devices and systems may be integrated into surgical instruments and procedures used for fluorescence-guided diagnostic and surgery applications.

“Target tissue” refers to any bodily tissues, organs, glands, cells that are in either normal or defected conditions and can include but is not limited to breast, prostate, liver, colon, lung, pancreas, stomach, brain, liver, kidney, head, neck, and/or bladder. In some preferred embodiments, the target tissue is a tumor. As used herein, the term “tumor” refers to an abnormal growth of tissue resulting from uncontrolled, progressive multiplication of cells and serving no physiological, but rather pathological, functions.

In some embodiments, the target tissue is a diseased tissue being considered for resection through a surgical process. In some embodiments, the target tissue is a cancerous tissue, including metastatic tissue. In some embodiments, the fluorescence-guided diagnostic and surgery applications refers to fluorescence imaging of target tissues and/or tumors. In some embodiments, the fluorescence-guided diagnostic and surgery applications refers to tissue involved in inflammation, diabetes, cardiovascular diseases (including, for example, Atherosclerosis), neurodegenerative disorders and cancer.

As such, the disclosure provides methods for simultaneous multi-wavelength fluorescence imaging comprising acquiring one or more fluorescent images of at least one fluorophore or fluorescent probe in a target tissue with a device or system as described herein. In some embodiments, the methods further comprise detecting one or more white light images of the target tissue. In some embodiments, the methods further comprise administering at least one fluorophore or fluorescent probe to the target tissue or subject.

In some embodiments, the methods can be used to determine the prognosis of a disease condition or monitoring a disease condition over time or pre-or post-intervention (e.g., surgery, drug regimen, and the like) in a target tissue in a subject comprising administering to a fluorophore or fluorescent probe specific for the disease or condition in the target tissue, and visualizing and comparing a fluorescent pattern in the diseased tissue with that or a normal tissue or the same target tissue over time, e.g., after an intervention. As used herein, the term “prognosis” refers to a predicted and/or expected course of a disease including various developments, changes, and outcomes of the disease.

In some embodiments, the methods can be used for intraoperative visualization of tumors wherein at least one fluorophore or fluorescent probe specific to a target tumor is administered to a subject. As such, the methods allow diagnosing and/or detection of cancers. In some embodiments, the methods improve tissue resection methods, e.g., tumor resections.

1. An optical system comprising
a handheld optical device comprising:
a light collection unit that collects light from a desired target area;
an electronic tunable lens configured to receive output from the lens assembly; and
one or more detection assemblies configured to receive and detect one or more desired wavelength ranges of light from output of the tunable lens.

2. The optical system of claim 1, wherein the handheld optical device comprises two detection assemblies.

3. The optical system of claim 1, wherein the one or more detection assemblies comprise a fluorescent light detection assembly.

4. The optical system of claim 3, wherein the fluorescent light detection assembly comprises a multi-band filter.

5. The optical system of claim 1, wherein the one or more detection assemblies comprise a white light detection assembly.

6. The optical system of claim 1, wherein the one or more detection assemblies comprise: one or more of: lenses, collimators, and filters; and a detector.

7. The optical system of claim 1, wherein the handheld optical device further comprises a beam divider to split light output of the tunable lens to the one or more detection assemblies.

8. The optical system of claim 1, wherein the handheld optical device further comprises one or more mirrors to direct light path(s) to the one or more detection assemblies.

9. The optical system of claim 1, wherein the light collection unit is a lens assembly.

10. The optical system of claim 1, wherein the light collection unit is an endoscope or colposcope attachment.

11. The optical system of claim 1, wherein the handheld optical device further comprises a distance sensor in communication with the electronic tunable lens.

12. The optical system of claim 11, wherein the distance sensor is at or near distal end of the light collection unit.

13. The optical system of claim 11, wherein the device or system comprises a focusing controller.

14. The optical system of claim 1, wherein the system comprises a light source assembly for providing one or more transient and temporally separate illumination and/or excitation lights to a target.

15. The optical system of claim 14, wherein the illumination and/or excitation lights are switched at a rate of at least 100 Hertz.

16. The optical system of claim 14, wherein the light source assembly comprises a fluorescence excitation light source.

17. The optical system of claim 1, wherein the light source assembly comprises a white light source.

18. The optical system of claim 1, wherein the light source assembly is integral to the handheld optical device.

19. The optical system of claim 1, wherein the light source assembly is separate from the handheld optical device.

20-32. (canceled)

33. A method for multi-wavelength fluorescence imaging comprising acquiring one or more fluorescence images of at least one fluorophore or fluorescent probe in a target tissue with a system of claim 1.

34-37. (canceled)
